(19) United States
(12) Patent Application Publication
(10) Pub. No.: US 2021/0250538 A1
(43) Pub. Date: Aug. 12, 2021

(54) ELECTRONIC APPARATUS, METHOD OF DISPLAY CONTROL, AND NON-TRANSITORY COMPUTER-READABLE RECORDING MEDIUM

(71) Applicant: SHARP KABUSHIKI KAISHA, Sakai City (JP)

(72) Inventors: MITSUHIRO HANEDA, Sakai City (JP); NORIAKI MURAKAMI, Sakai City (JP); SHOHEI TAKAI, Sakai City (JP); TAKANORI SAITO, Sakai City (JP)

(21) Appl. No.: 17/169,960

(22) Filed: Feb. 8, 2021

(30) Foreign Application Priority Data
Feb. 12, 2020 (JP) 2020-021807

(51) Int. Cl. H04N 5/45; G09G 5/14

(52) U.S. Cl. CPC H04N 5/45; G09G 2340/045; G09G 5/14

(57) ABSTRACT

An electronic apparatus includes: a display device; a storage; and a controller, wherein the controller is configured to perform processes of extracting, from a moving picture acquired from the storage, subjects included in the moving picture and information about each of the subjects, selecting a target of magnification display from among the subjects by referring to the information, and controlling the display device to display the moving picture with a region including the target being magnified.

### CROSS-REFERENCE TO RELATED APPLICATION

The present application claims priority from Japanese Application JP 2020-21807, the content of which is hereby incorporated by reference into this application.

### BACKGROUND OF THE INVENTION

### 1. Field of the Invention

The present invention relates to an electronic apparatus, a method of display control, and a non-transitory computer-readable recording medium.

### 2. Description of the Related Art

A conventionally known technique is tracking a part of a moving picture and separately displaying the picture. For instance, Japanese Patent Application Laid-Open No. 2014-220724 discloses a display controller. The controller continues displaying, in a first display region, the image of a first person selected as a tracking target from among persons appearing in a moving picture, and displays, in a second display region, the image of a second person appearing in the moving picture at the time when playback is ongoing.

### SUMMARY OF THE INVENTION

The conventional technique unfortunately requires a user to find for himself/herself a target tracking subject and perform a selecting operation.

It is an object of one aspect of the present invention to display a subject under magnification without a user operation.

To solve the above problem, an electronic apparatus according to one aspect of the present invention includes a display device, a storage, and a controller. The controller performs the following processes: extracting, from a moving picture acquired from the storage, subjects included in the moving picture and information about each of the subjects; selecting a target of magnification display from among the subjects by referring to the information; and controlling the display device to display the moving picture with a region including the target being magnified.

The aspect of the present invention offers magnification display of the subject without a user selection.

### BRIEF DESCRIPTION OF THE DRAWINGS

FIG. 1 is a block diagram illustrating a hardware configuration of a display system according to a first preferred embodiment of the present invention;

FIG. 2 is a block diagram illustrating a functional configuration of the display system according to the first preferred embodiment of the present invention;

FIG. 3 is a flowchart showing a process performed by a display controller according to the first preferred embodiment of the present invention;

FIG. 4 illustrates an example screen of a display device according to the first preferred embodiment of the present invention;

FIG. 5 illustrates an example screen of the display device according to the first preferred embodiment of the present invention; and

FIG. 6 illustrates an example screen of the display device according to the first preferred embodiment of the present invention.

### DETAILED DESCRIPTION OF THE INVENTION

### First Preferred Embodiment

A first preferred embodiment of the present invention will be detailed.

A display system (electronic apparatus) 1 according to this preferred embodiment zooms a moving picture not during video recording, but during video playback. The display system 1 uses existing techniques, such as object recognition, composition determination, and person recognition, to determine a tracking target (a subject to be zoomed) during video playback. This offers a zoom-in playback without user taps for searching for the tracking target.

Configuration of Display System 1

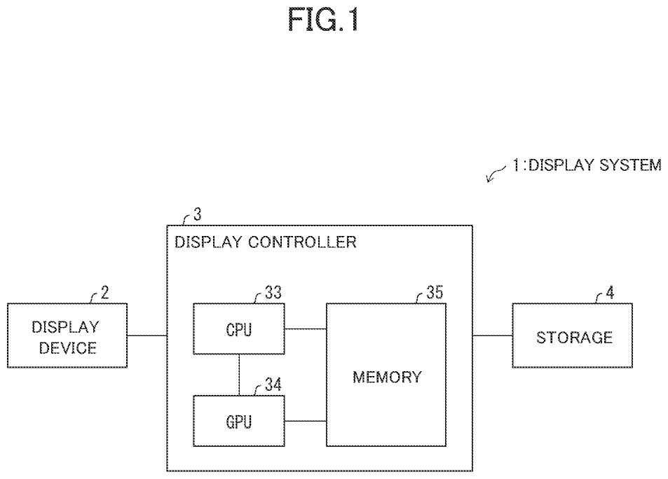

FIG. 1 is a block diagram illustrating a hardware configuration of the display system 1 according to this preferred embodiment. The display system 1 includes a display device 2, a display controller (controller) 3, and a storage 4, as illustrated in FIG. 1.

The display device 2 displays an image at a predetermined resolution (display resolution). The display device 2 is composed of, but not limited to, an organic electroluminescent (EL) display, a liquid crystal display, or a projector.

The display controller 3 controls the display device 2, and is connected to the display device 2 and the storage 4. The display controller 3 is composed of, for instance, an integrated circuit (e.g., an SoC or system-on-a-chip). The display controller 3 is the body of equipment, such as a smartphone, a tablet terminal, and a PC. In some preferred embodiments, the display controller 3 may control functions (e.g., communication control) other than display.

The storage 4 stores various information items. The storage 4 is, but not limited to, a hard disk drive (HDD) or solid state drive (SSD) incorporated into the display controller 3 or externally connected. The storage 4 stores programs (e.g., an operation system and an application) and data necessary for operating the display system 1.

Hardware Configuration of Display Controller 3

The display controller 3 includes a central processing unit (CPU) 33, a graphics processing unit (GPU) 34, and a memory 35.

The CPU 33 performs various calculations, such as the operation of an application. The GPU 34 performs a process relating to image processing. The memory 35 temporarily stores information necessary for the calculations and the image processing.

In some preferred embodiments, the display device 2 may include the display controller 3. The display controller 2 in this case is the body of equipment, such as a smartphone, a tablet terminal, and a PC.

Functional Configuration of Display Controller 3

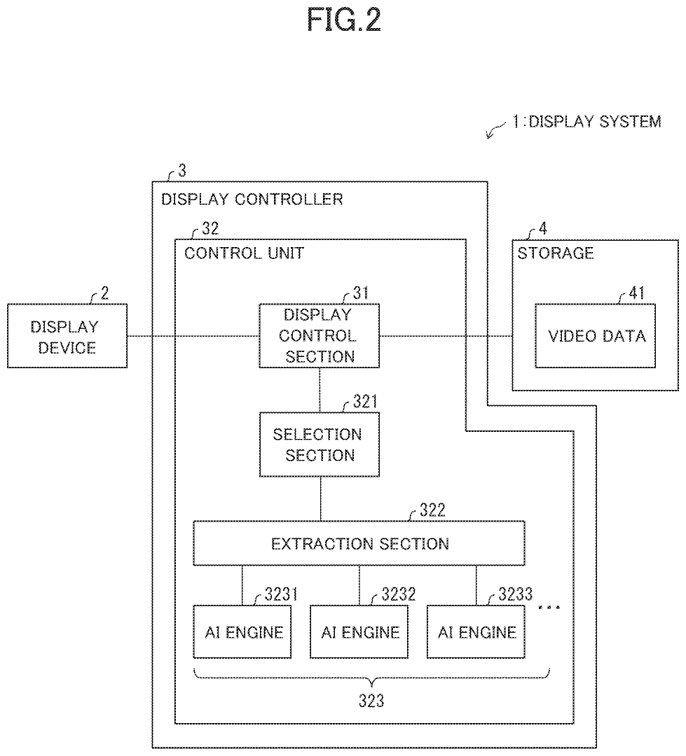

FIG. 2 is a block diagram illustrating a functional configuration of the display system 1 according to this preferred embodiment. The display controller 3 includes a control unit 32, as illustrated in FIG. 2. The control unit 32 includes a display control section 31, a selection section 321, an extraction section 322, and an AI engine 323. The storage 4 stores video data (moving picture) 41.

The display control section 31 controls the display device 2 to display the video data 41 stored in the storage 4. Upon acquiring information about a zoom region from the selection section 321, the display control section 31 refers to this zoom-region information and controls the display device 2 to display the video data (moving picture) 41 with a region including a target subject for magnification display being zoomed in (magnified). The zoom-region information includes the range of a region including the subject, and the ratio of magnification of the region. In some preferred embodiments, the display control section 31 may zoom out (scale down) the region including the subject.

The selection section 321 selects a target of magnification display from among subjects included in the video data 41, by referring to information about each subject included in the video data 41. To be specific, the selection section 321, when selecting a target of magnification display, uses a result of recognition in the AI engine 323, acquired from the extraction section 322, to select a zoom region in the video data 41 and generate zoom-region information including the range of the zoom region. The selection section 321 then determines the ratio of magnification of a region including the selected target subject for magnification display, adds the ratio to the zoom-region information, and then outputs the zoom-region information to the display control section 31.

The extraction section 322 extracts, from the video data 41 stored in the storage 4, the subjects included in the video data 41 and subject information (information) about each subject. The subject information includes at least any one of the following: the designation, size and position of each subject; the presence or absence of the face of each subject; the facial expression of each subject, the movement and direction of each subject, the number of subjects, the brightness of each subject; and information about the composition of each subject. To be specific, the extraction section 322 controls the AI engine 323 to analyze the video data 41 acquired from the display control section 31, and outputs the result of recognition in the AI engine 323 to the selection section 321.

The designation of each subject herein includes the kind of the subject (e.g., a human, a dog, and a cat), and for a human, the designation includes the personal name of the subject.

The information about the composition of each subject is herein information about the composition of the frame of a moving picture, and refers to whether the composition defined by the subject and its background is good or bad; to be more specific, this information preferably includes an evaluation about the composition.

The AI engine 323 analyzes the video data individually using proper methods, and outputs recognition results relating to the subjects included in the video data 41 to the selection section 321 via the extraction section 322. For instance, an AI engine 3231 performs composition determination on the video data 41. The composition determination refers to determining whether the evaluation about the composition of a post-zoom image is equal to or greater than a predetermined value. The AI engine 3231 learns an image that is commonly recognized to have a good composition, and puts a high score (evaluation) to the video data 41 that is close to such an image.

An AI engine 3232 performs object recognition on the video data 41. The object recognition refers to recognizing particular objects, including humans, dogs, and cats. An AI engine 3233 performs person recognition on the video data 41. The person recognition refers to recognizing persons who are entered in the video data 41 in advance.

In some preferred embodiments, any number of AI engines 323 may be provided, and the AI engine 323 may use any determination method and any recognition method other than those described above. In addition, the AI engine 323 does not have to perform person recognition. That is, no AI engine 3233 that performs person recognition may be provided.

Process Performed by Display Controller 3

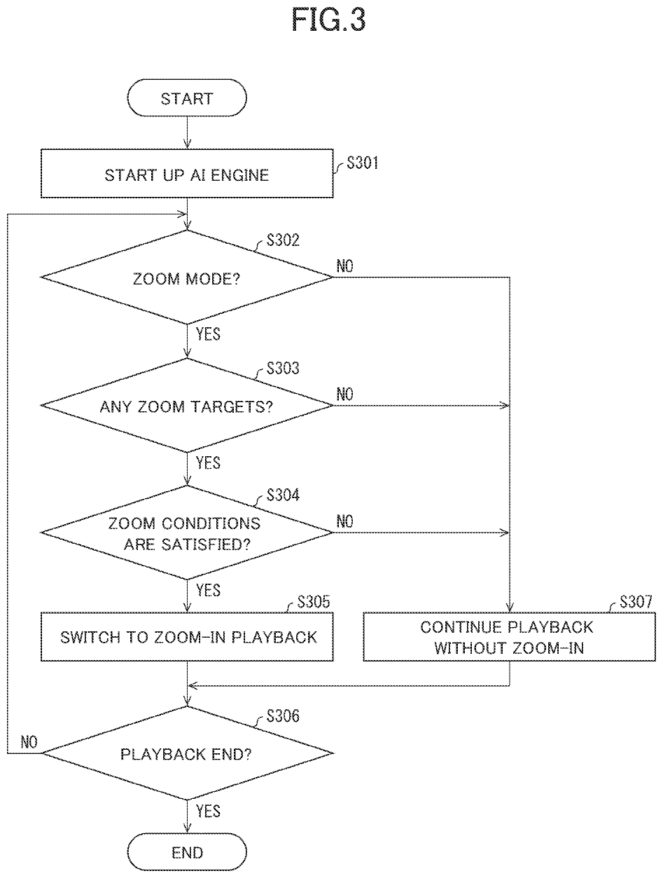

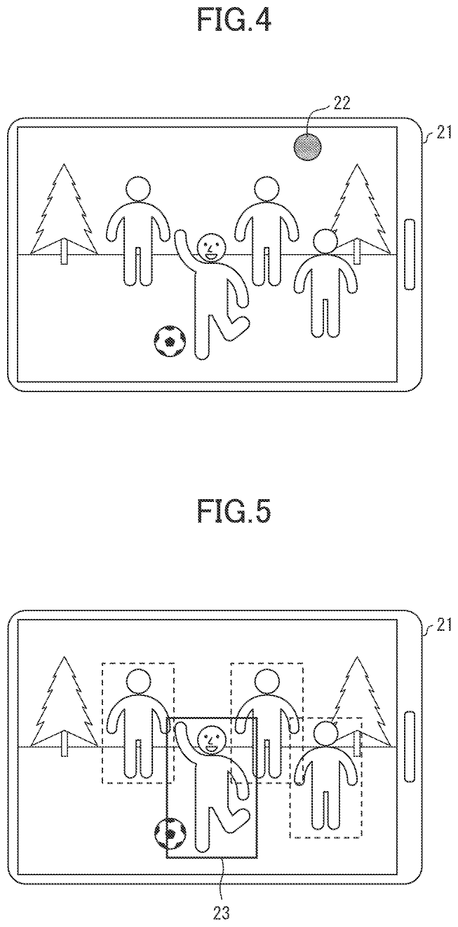

FIG. 3 is a flowchart showing a process performed by the display controller 3 according to this preferred embodiment. FIGS. 4 and 5 illustrate examples of a screen 21 of the display device 2 according to this preferred embodiment. The process in the display controller 3 will be described with reference to FIGS. 3 to 6.

The process in the display controller 3 starts when, for instance, a user starts up a video playback application installed in a smartphone or other machines. Upon the starting-up of the video playback application, the display control section 31 plays back a moving picture. That is, the display control section 31 controls the display device 2 to display the video data 41 stored in the storage 4 as is without zoom.

When controlling the display device 2 to display the moving picture, the display control section 31 switches between overall display of the moving picture and magnification display of subjects included in the moving picture in response to user operations while playing back the moving picture. The display control section 31 zooms in a region determined using the AI engine 323 and plays back the region in response to a change in the video playback to a zoom mode, where the subject in the video data 41 undergoes magnification display. The display controller 3 herein has the function of video playback.

Step S301

The control unit 32 of the display controller 3 starts up the AI engine 323. In this case, the extraction section 322 starts up at least one AI engine 323 (a single AI engine 323 or multiple AI engines 323 may be provided) in accordance with, for instance, the CPU performance and memory capacity of the display controller 3.

Step S302

The control unit 32 determines whether the video playback is in the zoom mode. The display controller 3 controls the display device 2 to display, on the screen 21, a zoom-in playback button 22, which is operated by the user for magnification display of the subject, as illustrated in FIG. 4 for instance. Upon a user touch on the zoom-in playback button 22, the video playback in the display controller 3 changes to the zoom mode. Herein, the zoom mode is released when the user touches the zoom-in playback button 22 again or a zoom-in playback is performed for a predetermined time.

If the video playback is in the zoom mode (if YES in Step S302), the control unit 32 performs determination in Step S303. That is, when extracting subjects and information about each subject from the moving picture, the extraction section 322 extracts the subjects and the information about each subject from the video data 41 in response to a switch to magnification display of a subject included in the video data 41. This process step is called an extraction step. If the video playback is not in the zoom mode (if NO in Step S302), the control unit 32 performs a process step in Step S307.

Step S303

The extraction section 322 of the control unit 32 uses the AI engine 323, already started up in Step S301, to determine whether there are zoom targets in the video data 41 being played back at this time. Different AI engines 323 perform different kinds of determination on whether there are zoom targets.

For instance, the AI engine 3231 determines whether an enlarged image of the video data 41 has a proper composition (the evaluation about a composition is equal to or greater than a predetermined value). The enlarged image of the video data 41 refers to an enlarged image of a region including an object, a person and other things extracted by an AI engine other than the AI engine 3231.

Further, the AI engine 3232 determines whether there are particular objects, including humans, dogs, and cats, in the video data 41. Further, the AI engine 3233 determines whether there are persons entered in the video data 41 in advance. It is noted that the control unit 32 may determine whether there are zoom targets by using a method other than that described above.

If there are zoom targets in the video data 41 (if YES in Step S303), the control unit 32 performs determination in Step S304. In this case, the screen 21 displays, for instance, a rectangular solid-line frame and rectangular broken-line frames as illustrated in FIG. 5, each of which indicating that the subjects in these frames are zoom targets. It is noted that a rectangular frame that indicates a zoom target does not necessarily have to be displayed. If there are no zoom targets in the video data 41 (if NO in Step S303), the control unit 32 performs a process step in Step S307.

Step S304

The control unit 32 uses the AI engine 323 to determine whether the video data 41 satisfies zoom conditions. This process step includes further determining whether one or more zoom targets determined to be appearing in the video data 41 in Step S303 should be actually displayed under magnification.

For instance, the AI engine 323 calculates scores of the individual conditions listed below for each zoom target. The extraction section 322 outputs the calculated scores to the selection section 321. The selection section 321 weights the individual scores in accordance with the order of priority of the conditions for each zoom target, and sums the scores. Based on the sum score, the selection section 321 determines, for each zoom target, whether the zoom conditions are satisfied. The selection section 321 may calculate scores for each zoom target by evaluating, in particular, the size and position of the subject, the presence or absence of the subject's face, and the facial expression of the subject.
The size of a subject (equal to or greater than a predetermined size)
The position where a subject is appearing (the vicinity of the center of an enter image)
The presence or absence of the face of a subject (whether the face is included)
The facial expression of a subject (whether the subject is smiling)
The movement of a subject
The direction of a subject
The number of subjects
The brightness of a subject
The composition of a subject

If the video data 41 satisfies the zoom conditions (if YES in Step S304), the control unit 32 performs a process step in Step S305. If the video data 41 does not satisfy the zoom conditions (if NO in Step S304), the control unit 32 performs a process step in Step S307.

Step S305

Step S305 is a selection step, where the selection section 321 of the control unit 32 selects a target of actual magnification display from among one or more zoom targets satisfying the zoom conditions. The selection section 321 may select a zoom target with a large sum of the scores of the individual conditions, calculated in Step S304. As illustrated in FIG. 5 for instance, the selection section 321 selects a subject included in a rectangular solid-line frame 23 as the target of magnification display.

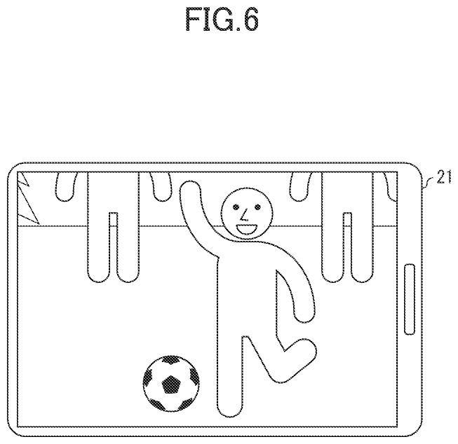

The selection section 321 then outputs zoom-region information about the selected target to the display control section 31. The display control section 31 acquires the zoom-region information from the selection section 321, and based on this information, the display control section 31 switches the playback of the video data 41 to zoom-in playback, where a region including the target undergoes magnification display. This process step is called a display control step. For instance, the display control section 31 switches to the screen 21 shown in FIG. 6, which includes an enlarged image of a region within the rectangular frame 23 in FIG. 5.

During the zoom-in playback, the display control section 31 uses the AI engine 323 to track the selected target, and controls the display device 2 to display the region including the target under magnification.

When the target is no longer included in a frame in the video data 41, the control unit 32 anew performs determination in Steps S303 and S304. Upon determining a new target of magnification display, the display control section 31 performs zoom-in playback on the new target. When no zoom targets are appearing or the zoom conditions are not satisfied, the display control section 31 releases the zoom mode and plays back the moving picture without size change.

Step S306

The control unit 32 determines whether to end the video playback. For instance, the control unit 32 determines whether the user has performed an operation for instructing playback end on a screen of the video playback application.

If the video playback is to be ended (if YES in Step S306), the control unit 32 ends the video playback application to end the series of the video playback process. If the video playback is not to be ended (if NO in Step S306), the control unit 32 returns to the determination in Step S302.

In some preferred embodiments, the control unit 32 may perform the determination in Steps S303 and S304 for each predetermined time. This enables zoom-target switching in accordance with video circumstances for each predetermined time.

Step S307

The control unit 32 performs no process, and the selection section 321 outputs nothing to the display control section 31, when the video playback is not in the zoom mode, no zoom targets are appearing in the video data 41, or the video data 41 does not satisfy the zoom conditions. The display control section 31 accordingly continues the playback without zoom-in and size change.

In some preferred embodiments, when no zoom targets are appearing in the video data 41 or the video data 41 does not satisfy the zoom conditions, the display control section 31 may control the display device 2 to display a notification indicating that zoom-in playback instructed by the user has failed.

In some preferred embodiments, when multiple zoom target subjects are appearing in the video data 41, the display control section 31 may refer to the zoom-region information in response to a user operation to enable a switch in magnification target from a currently tracking target (magnification target) subject to a subject having the second highest priority (the second largest total score).

### Effects of First Preferred Embodiment

The display controller 3 according to this preferred embodiment calculates a tracking target and the ratio of magnification from information acquired from subjects. The display controller 3 also generates zoom-region information (the position of a zoom frame surrounding a subject, and information for zoom, including an ID of the subject). The ID of the subject refers to an identifier through which each subject can be identified even when there are multiple zoom target subjects. The display controller 3 refers to the zoom-region information to generate, from an originally recorded moving picture, a zoomed moving picture of the tracking target, and at the same time play back the zoomed moving picture. Consequently, the display controller 3, which zooms a moving picture during playback, allows a user to record the moving picture without concern for zoom.

The aforementioned configuration includes determining a tracking target to zoom in the tracking target during video playback. This eliminates the need for the user to find and select for himself/herself a tracking target.

### Example Implementation by Software

The control blocks of the display controller 3 (each section of the control unit 32) may be implemented by a logic circuit (hardware) formed in, for instance, an integrated circuit (IC chip) or by software.

For software, the display controller 3 includes a computer that executes commands of a program or software that implements each function. This computer includes, for instance, at least one processor (controller) and at least one computer-readable recording medium storing the program. The processor in the computer reads the program from the recording medium and executes the program, thus achieving the object of the present invention. The processor can be a central processing unit (CPU) for instance. The recording medium can be a non-transitory tangible medium, including a read only memory (ROM), a tape, a disk, a card, a semiconductor memory, and a programmable logic circuit. This computer may further include, but not limited to, a random access memory (RAM) that develops the program. The program may be supplied to the computer via any transmission medium (e.g., a communication network and a broadcast wave) that can transmit the program. One aspect of the present invention can be implemented also in the form of a data signal embodied by electronic transmission of the program and embedded in a carrier wave.

### SUMMARY

An electronic apparatus according to a first aspect of the present invention includes a display device, a storage, and a controller. The controller performs the following processes: extracting, from a moving picture acquired from the storage, subjects included in the moving picture and information about each of the subjects; selecting a target of magnification display from among the subjects by referring to the information; and controlling the display device to display the moving picture with a region including the target being magnified.

The aspect offers magnification display of the subject without a user operation.

In the first aspect, the electronic apparatus according to a second aspect of the present invention may be configured such that the information includes at least any one of the size of each of the subjects, the position of each of the subjects, the presence or absence of the face of each of the subjects, the facial expression of each of the subjects, the movement of each of the subjects, the direction of each of the subjects, the number of subjects, the brightness of each of the subjects, and the composition of each of the subjects.

In the first or second aspect, the electronic apparatus according to a third aspect of the present invention may be configured such that the selecting process includes determining the ratio of magnification of a region including a subject selected as the target.

This configuration enables the region including the subject to be displayed under magnification by using the determined ratio of magnification.

In the first to third aspects, the electronic apparatus according to a fourth aspect of the present invention may be configured such that the controlling process includes in response to user operations, switching between overall display of the moving picture and magnification display of the subjects.

This configuration allows a user to easily switch between the overall display of the moving picture and the magnification display of the subjects.

In the fourth aspect, the electronic apparatus according to a fifth aspect of the present invention may be configured such that the extracting process includes extracting the subjects and the information from the moving picture in response to a switch to the magnification display of the subjects.

This configuration provides information necessary for the magnification display of the subjects.

A display controller according to a sixth aspect of the present invention controls a display device. The display controller includes the following: an extraction section that extracts, from a moving picture, subjects included in the moving picture and information about each of the subjects; a selection section that selects a target of magnification display from among the subjects by referring to the information; and a display control section that controls the display device to display the moving picture with a region including the target being magnified.

A method of display control according to a seventh aspect of the present invention is a method for controlling a display device. The method includes the following steps: extracting, from a moving picture, subjects included in the moving picture and information about each of the subjects; selecting a target of magnification display from among the subjects by referring to the information; and controlling the display device to display the moving picture with a region including the target being magnified.

The display controller according to each aspect of the present invention may be implemented by a computer. In this case, the scope of the present invention includes a control program of the display controller implemented by the computer operating as each unit (software components) included in the display controller. The scope also includes a computer-readable recording medium recording the control program.

The present invention is not limited to the foregoing preferred embodiment. Numerous modifications can be devised within the scope of the claims. The technical scope of the present invention includes as well a preferred embodiment obtained in combination, as appropriate, with technical means disclosed in individual different preferred embodiments. Furthermore, combining the technical means disclosed in the individual preferred embodiments can provide a new technical feature.

While there have been described what are at present considered to be certain embodiments of the invention, it will be understood that various modifications may be made thereto, and it is intended that the appended claim cover all such modifications as fall within the true spirit and scope of the invention.

What is claimed is:

1. An electronic apparatus comprising:
a display device;
a storage; and
a controller,
wherein the controller is configured to perform processes of
extracting, from a moving picture acquired from the storage, subjects included in the moving picture and information about each of the subjects,
selecting a target of magnification display from among the subjects by referring to the information, and
controlling the display device to display the moving picture with a region including the target being magnified.

2. The electronic apparatus according to claim 1, wherein
the information includes at least any one of a size of each of the subjects, a position of each of the subjects, presence or absence of a face of each of the subjects, a facial expression of each of the subjects, a movement of each of the subjects, a direction of each of the subjects, the number of the subjects, brightness of each of the subjects, and a composition of each of the subjects.

3. The electronic apparatus according to claim 1, wherein
the selecting process comprises
referring to the information about a subject selected as the target, to determine a ratio of magnification of a region including the selected subject.

4. The electronic apparatus according to claim 1, wherein
the controlling process comprises
in response to user operations, switching between overall display of the moving picture and magnification display of the subjects.

5. The electronic apparatus according to claim 4, wherein
the extracting process comprises
extracting the subjects and the information from the moving picture in response to a switch to the magnification display of the subjects.

6. A method of display control, the method being used for controlling a display device, the method comprising the steps of:
extracting, from a moving picture, subjects included in the moving picture and information about each of the subjects;
selecting a target of magnification display from among the subjects by referring to the information; and
controlling the display device to display the moving picture with a region including the target being magnified.

7. A non-transitory computer-readable recording medium recording a control program for a computer to execute a process, the computer controlling a display device, the process comprising the steps of:
extracting, from a moving picture, subjects included in the moving picture and information about each of the subjects;
selecting a target of magnification display from among the subjects by referring to the information; and
controlling the display device to display the moving picture with a region including the target being magnified.
